(19) United States
(12) Patent Application Publication
(10) Pub. No.: US 2005/0005969 A1
(43) Pub. Date: Jan. 13, 2005

(54) [WATER HAMMER ARRESTER, LIQUID SUPPLY APPARATUS AND METHOD OF PREVENTING WATER HAMMER EFFECT]

(76) Inventors: SHIN-TONG WU, NANTOU COUNTY (TW); MING-JEN HUANG, MIAOLI COUNTY (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,054

(22) Filed: Sep. 5, 2003

(30) Foreign Application Priority Data
Jul. 8, 2003 (TW) 92118566

(51) Int. Cl. G05D 7/00

(52) U.S. Cl. 137/205.5

(57) ABSTRACT

A water hammer arrester, a liquid supply apparatus and a method of preventing water hammer effect are provided. The water hammer arrester arrests the water hammer effect in a pipeline linking up a liquid tank to a water supply point. The water hammer arrester comprises a pressure sensor, a proportional-integral-differential (PID) control module and a control valve. The pressure sensor is set between the liquid tank and the liquid supply point. The PID control module and the pressures sensor are connected together. The control valve is set in the pipeline with connection to the PID control module. The PID control module controls the operation of the control valve according to the signals received from the pressure sensor. The water hammer arrester relieves excess pressure within the pipeline automatically according to sensed internal pressure so that damage to the pipeline due to the sudden shut down of a check valve is prevented.

### BACKGROUND OF INVENTION

1. Field of the Invention

The present invention relates to an apparatus for preventing water hammer effect. More particularly, the present invention relates to a water hammer arrester, a liquid supply apparatus and a method of preventing wafer hammer effect.

2. Description of the Related Art

Most liquid supply systems such as a water supply apparatus relies on a pump to transfer water from a water tank to a location where the water is required. When power to the pump is cut, the vanes of the pump will continue to rotate for a short period due to inertia so that the lifting power of the pump drops gradually. However, when the lifting pressure is smaller than the static pressure due to the potential difference between the water tank and the water supply point, the flow of water will reverse within the pipeline and impact the still-rotating vanes. This causes the so-called water hammer effect on the pump and pipeline. To prevent this from happening, a check valve with a plate design is normally installed along the pipeline. When the water supply system is in operation, the check valve permits water to pass through unhindered. On the other hand, when power to the water supply system is shut, the check valve will also be shut immediately stopping any back flow of liquid in the pipeline into the tank.

Nevertheless, due to the sudden shut down of the check valve, a moderately large water hammering force is often created especially when the difference in potential level between the water tank and the water supply point is large. If the back-flow pressure exceeds the material strength of the pipeline, a portion of the pipeline close to the check valve may even crack.

### SUMMARY OF INVENTION

Accordingly, one object of the present invention is to provide a water hammer arrester, a liquid supply apparatus and a method of preventing water hammer effect capable of automatically relieving pressure according to the variation of pressure within a pipeline.

A second object of this invention is to provide a water hammer arrester, a liquid supply apparatus and a method of preventing water hammer effect capable of actively lowering the water hammer pressure within a pipeline to a minimum level.

To achieve these and other advantages and in accordance with the purpose of the invention, as embodied and broadly described herein, the invention provides a water hammer arrester. The water hammer arrester provides an effective means of arresting the water hammer effect between a liquid tank and a liquid supply point. The liquid tank and the liquid supply point are connected through a pipeline. The water hammer arrester comprises a pressure sensor, a proportional-integral-differential (PID) control module and a control valve. The pressure sensor is set between the liquid tank and the liquid supply point for detecting the pressure within the pipeline. The PID control module is connected to the pressure sensor for sensing the signals from the pressure sensor. The control valve is set in the pipeline and connected to the PID control module. The PID control module controls the operation of the control valve.

This invention also provides a liquid supply apparatus for delivering liquid to a liquid supply point. The liquid supply apparatus comprises a liquid tank, a pipeline, a pump, a check valve and at least a wafer hammer arrester. The pipeline connects the liquid tank and the liquid supply point. The pump is set between the liquid tank and the liquid supply point for pumping liquid from the liquid tank to the liquid supply point. The check valve is set somewhere along the pipeline between the pump and the liquid supply point for stopping the back flow of liquid to the pump after the pump is shut down. The water hammer arrester is set between the check valve and the liquid supply point. The water hammer arrester comprises a pressure sensor, a proportional-integral-differential (PID) control module and a control valve. The pressure sensor is used for detecting the pressure within the pipeline. The PID control module is connected to the pressure sensor for sensing the signals from the pressure sensor. The control valve is set within the pipeline with connection to the PID control module. The PID control module controls the control valve to perform linear shutting operations.

This invention also provides a method of preventing water hammer effect using a water hammer arrester. The method includes attaching a water hammer arrester to a pipeline so that excess pressure within the pipeline is automatically relieved according to the change in pressure within the pipeline. The water hammer arrester comprises a pressure sensor, a proportional-integral-differential (PID) control module and a control valve.

In brief, this invention provides a water hammer arrester attached to a pipeline for relieving excess pressure within the pipeline according to the pipeline pressure. Hence, pipeline hammering resulting from a sudden shut down of a check valve is completely avoided.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic layout of a liquid supply apparatus according to one preferred embodiment of this invention.

FIG. 2 is a flow chart showing the steps for preventing the water hammer effect using a water hammer arrester according to one preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

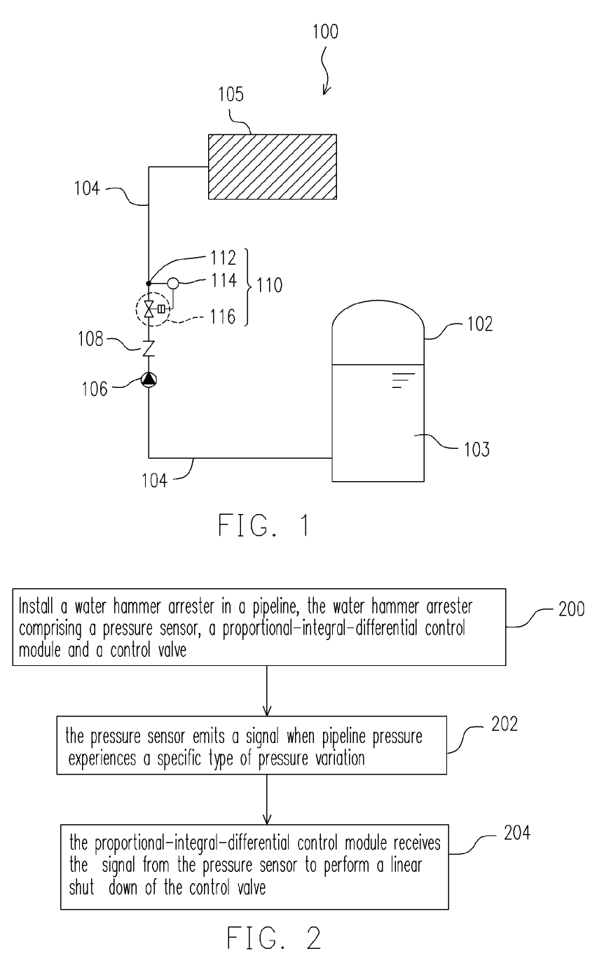

FIG. 1 is a schematic layout of a liquid supply apparatus according to one preferred embodiment of this invention. As shown in FIG. 1, the liquid supply apparatus 100 of this invention is used for supplying a liquid 103 to a liquid supply point 105. The liquid supply apparatus 100 comprises a liquid tank 102, a pipeline 104, a pump 106, a check valve 108 and at least a water hammer arrester 110. The pipeline 104 connects the liquid tank 102 and the liquid supply point 105 together. The liquid tank 102 is set under the liquid supply point 105, for example. The pump 106 is set between the liquid tank 102 and the liquid supply point 105 for pumping liquid 103 from the tank 102 to the liquid supply point 105. The check valve 108 is set somewhere along the pipeline 104 between the pump 106 and the liquid supply point 105 for preventing back flow of the liquid 103 into the pump 106 after the pump is shut down. The check valve 108 can be a full open type of check valve. The water hammer arrester 110 is set between the check valve 108 and the liquid supply point 105. The water hammer arrester 110 furthermore comprises a pressure sensor 112, a proportional-integral-differential (PID) control module 114 and a control valve 116. The water hammer arrester 110 is an L-shaped water hammer arrester, an I-shaped water hammer arrester, a T-shaped water hammer arrester or other angle-valve type of water hammer arrester. In general, the number of water hammer arresters 110 attached to the pipeline 104 can be increased according to the pipeline design and actual requirements.

The pressure sensor 112 within the water hammer arrester 110 senses the pressure within the pipeline 104. The pressure sensor 112 may include a pressure level indicator (the position labeled 112) set in the pipeline 104. The proportional-integral-differential (PID) control module 114 is connected to the pressure sensor 112 for detecting pressure signals from the pressure sensor 112. The control valve 116 is set in the pipeline 104 with connection to the PID control module 114. The PID control module 114 controls the control valve to perform linear shut down operations. The control valve 116 is set in a pressured section of the pipeline 104 relative to the pressure level indicator of the pressure sensor 112.

The pressure supply apparatus mainly provides a water hammer arrester along a pipeline for automatically relieving excess pipeline pressure according to the change of pressure within the pipeline. The steps for operating the water hammer arrester are shown in FIG. 2. In step 200, a water hammer arrester is installed alongside a pipeline. The water hammer arrester comprises a pressure sensor, a proportional-integral-differential control module and a control valve. In step 202, the pressure sensor generates a signal when a specific pressure change within the pipeline is sensed. Using the liquid supply apparatus shown in FIG. 1 as an example, pressure within the pipeline 104 will continuously drop after the pump 106 has been shut. However, due to the water hammer effect, pressure within the pipeline will suddenly increase when the pressure has dropped to a minimum point. To prevent the water hammer effect or the sudden increase in pressure within the pipeline, the “specific pressure change” before the pressure drops to the minimum point is gauged. In step 204, the PID control module controls the control valve to perform a linear shut down after receiving signals from the pressure sensor.

In summary, one major aspect of this invention is the setup of a water hammer arrester alongside a pipeline to relieve excess pressure within the pipeline automatically. Hence, water hammer effect resulting from sudden shut down of the check valve is prevented.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A water hammer arrester for arresting the water hammer effect between a liquid tank and a liquid supply point connected via a pipeline, the water hammer arrester comprising:
a pressure sensor set between the liquid tank and the liquid supply point for sensing the pressure within the pipeline;
a proportional-integral-differential (PID) control module connected to the pressure sensor for detecting signals submitted by the pressure sensor; and
a control valve connected to the PID control module and set in the pipeline, wherein the PID control module controls the operation of the control valve.

2. The water hammer arrester of claim 1, wherein the pressure sensor furthermore comprises a pressure level indicator set in the pipeline.

3. The water hammer arrester of claim 1, wherein the control valve is set in a pressured section relative to the pressure level indicator.

4. A liquid supply apparatus for delivering liquid to a liquid supply point, the liquid supply apparatus comprising:
a liquid tank;
a pipeline connecting the liquid tank and the liquid supply point;
a pump set between the liquid tank and the liquid supply point for pumping liquid from the liquid tank to the liquid supply point;
a check valve set along the pipeline somewhere between the pump and the liquid supply point for stopping the back flow of liquid after shutting down the pump; and
at least a water hammer arrester set between the check valve and the liquid supply point, the water hammer arrester having:
a pressure sensor for sensing the pressure within the pipeline;
a proportional-integral-differential (PID) control module connected to the pressure sensor for detecting signals submitted by the pressure sensor; and
a control valve connected to the PID control module and set in the pipeline, wherein the PID control module controls the operation of the control valve.

5. The liquid supply apparatus of claim 4, wherein the liquid tank is set underneath the liquid supply point.

6. The liquid supply apparatus of claim 4, wherein the pressure sensor furthermore comprises a pressure level indicator set in the pipeline.

7. The liquid supply apparatus of claim 4, wherein the control valve is set in a pressured section relative to the pressure level indicator.

8. The liquid supply apparatus of claim 4, wherein the water hammer arrester is selected from a group consisting of an L-shaped water hammer arrester, an I-shaped water hammer arrester, a T-shaped water hammer arrester and other angle-valve water hammer arrester.

9. The liquid supply apparatus of claim 4, wherein the check valve comprises a full-open type of check valve.

10. A method of preventing water hammer effect through a water hammer arrester according to claim 1, comprising the step of:
installing a water hammer arrester along a pipeline so that excess pressure within the pipeline is automatically relieved according to the change in pressure within the pipeline, wherein the water hammer arrester comprises a pressure sensor, a proportional-integral-differential control module and a control valve.

11. The method of claim 10, wherein the process of relieving excess pressure according to the pressure change within the pipeline comprises:
the pressure sensor generates a signal when the pressure within the pipeline experiences a specific type of variation; and
the proportional-integral-differential control module controls the control valve to perform a linear shut down operation upon receiving a signal from the pressure sensor.

12. The method of claim 11, wherein the specific type of pressure variation within the pipeline includes a continuous drop in pressure to a minimum value within the pipeline.
